(19) United States
(12) Patent Application Publication
(10) Pub. No.: US 2019/0333033 A1
(43) Pub. Date: Oct. 31, 2019

(54) SYSTEM AND METHOD FOR CREATING, STORING AND TRANSFERRING UNFORGEABLE DIGITAL ASSETS IN A DATABASE

(71) Applicant: Keir Finlow-Bates, Kangasala (FI)

(72) Inventor: Keir Finlow-Bates, Kangasala (FI)

(21) Appl. No.: 15/965,926

(22) Filed: Apr. 29, 2018

(51) Int. Cl. G06Q 20/06; G06F 21/60; H04L 9/06; G06F 17/30; G06Q 20/38

(52) U.S. Cl. CPC G06Q 20/0658; G06F 21/602; G06Q 2220/00; G06F 17/30377; G06Q 20/3829; H04L 9/0637

(57) ABSTRACT

A system for creating, transferring and storing digital assets, such as a cryptocurrency, in which no central trusted authority is required, is presented. A plurality of databases are coupled to a blockchain, with each of the plurality of databases connected through a connective component. Each connective component monitors an associated database and the blockchain. A creation of a digital asset may be initiated by an entry in the associated database, and ownership of the digital asset ownership and associated properties are mirrored to the remainder of the plurality of databases through the blockchain and respective connective components. Subsequently a transfer of the digital asset may be initiated through a new entry to the associated database. The blockchain provides a final single view of a true state of the digital asset and acts as a validator and arbitrator for the creation and the transfer.

### TECHNICAL FIELD

This disclosure relates to computer systems and methods concerned with the creation, storage and transfer of unforgeable digital assets, and more specifically to the creation, storage and transfer of said unforgeable digital assets on a database.

### BACKGROUND

Distributed ledgers provided in, for example, a peer-to-peer network, such as the distributed ledger used in the Bitcoin cryptocurrency system, allow participants on the peer-to-peer network to create, own and transfer digital assets. In such systems, participants examine proposed data blocks containing transactions specifying asset creation and transferral, in order to verify that the transactions conform to a network agreed standard, rather than relying on a third-party trusted central authority to authorize the validity of the transactions. Such a system is known to those skilled in the art as a blockchain.

Blockchains are of interest to industries such as finance, banking, gambling, gaming, media, publishing, stock trading, and venture funding, as a blockchain may be used to create a digital representation of a currency, game token, casino chip, or share or stock, and subsequently transferring some or all of the digital representation between interested parties in a decentralized manner, that is, without requiring a centralized database or other data store and an associated company or organization to manage said centralized database or other data store.

A significant benefit of the blockchain is that the digital representation of an asset is unique and unforgeable, meaning that in the same manner as physical cash, it may be transferred from a first party to a second party, after which the first party no longer owns the digital representation and the second party does. To those skilled in the art, this is known as a solution to a double spend problem.

In a centralized system the double spend problem is overcome by a central authority, which oversees an ownership of various assets by various parties using a system, typically by maintaining ownership records in a database.

However, centralized systems have a number of problems. The central authority may have access to or the ability to gain access to and read all data in the system. Furthermore, central authorities usually charge for their services, resulting in higher costs for users of the system. Finally, the central authority may have the power to arbitrarily exclude or expel users from the system, or may even shut down the system entirely.

A problem of a cryptocurrency or digital asset register embodied in a blockchain, is that an implementation of such a blockchain system requires specific scarce skills and knowledge related to blockchain technology. Database skills and knowledge in comparison are common.

It is therefore the intention of the present disclosure to address the problem of enabling a database system to provide digital assets such as unique unforgeable assets, cryptocoins, or tokens, with a clear ownership, and an ability to transfer said digital assets in a decentralized fashion without recourse to a central authority.

### SUMMARY

In accordance with the present disclosure, a solution is provided for creating, storing and transferring digital assets through a medium of a database. The database may be one of: a hierarchical database, an SQL database, a NoSQL database, a file system, a spreadsheet.

For the purposes of this disclosure, a term “digital assets” may comprise one or more of: cryptocoins, unforgeable digital assets, tokens, unique digital assets, loyalty points, or digital credits.

Blockchain validators, comprising, in a preferred embodiment of the present disclosure, a plurality of network connected devices participating in maintaining and extending the blockchain, may receive data and messages over a peer-to-peer network, which they may package into a data block for potential inclusion in the blockchain. The data block may comprise a number of control messages instructing participants on the blockchain to take a one or more specific actions. Such control messages are referred to in the present disclosure as “messages” if they provide information, and “transactions” if they provide a report of a change. If the validators deem a transaction to be valid, that is, it complies with protocols and rules of the blockchain, the validators may add the transaction to the blockchain by including it in the data block.

In a preferred embodiment, a plurality of network connected devices, each comprising: one or more processors, and storage media comprising computer instructions, said plurality of network connected devices being connectible via a network to each other, arranged such that when computer instructions are executed on the one or more processors of a one or more of the plurality of network connected devices, operations are caused for creating digital assets.

In an embodiment, a first of the plurality of network connected devices may comprise one or more of: a network connectivity module, a connective component, a database.

Operations may commence by the first of the plurality of network connected devices initiating a creation of a digital asset, by adding an asset creation record to the database. The asset creation record may comprise a total quantity of the digital asset, and an owner of the digital asset.

Subsequently the connective component of the first of the plurality of network connected devices may detect a new presence of the asset creation record, and may respond by generating an asset creation message comprising some or all of a content of the asset creation record, and transmitting said asset creation message to a blockchain.

Operations may then proceed by a one or more of the remainder of the plurality of network connected devices, acting as validators, verifying that the asset creation message is valid.

On successful verification the one or more of the plurality of network connected devices may add the asset creation message to the blockchain, as described above in a definition of validators.

Subsequently, a second of the plurality of network connected devices, which in an embodiment may comprise one or more of: a second network connectivity module, a second connective component, a second database, may retrieve the asset creation message from the blockchain.

The second connective component may then generate a corresponding record comprising some or all of the asset creation message.

The second connective component may then insert the corresponding record into the second database.

In an embodiment of the asset creation record, the owner of the quantity of the digital asset may be identified through one or more of: a public cryptographic key, an IP address, an email address, a universal identification number, an identifier data structure.

In a further or alternate embodiment of the asset creation record, the asset creation record may comprise an initial quantity of the digital asset, a creation rate for further quantities of the digital asset, and a condition for a creation of further quantities of the digital asset.

The initial quantity may specify how many units or sub-units of the digital asset exist at a beginning of the existence of the digital asset.

The creation rate for further quantities of the digital asset may specify at what rate more of the digital asset is issued. For example, in one embodiment the creation rate may be a hundred units of the digital asset issued every hour. An another embodiment the creation rate may change over time, for example, the creation rate may start at 128 units of the digital asset issued every hour, and may halve every year, and finally becoming zero units after eight years.

The condition for the creation of further quantities of the digital asset may specify in what situations further units of the digital asset may be issued. For example, in one embodiment the condition may apply to the creation rate, that is the condition may be that a further issuance occurs regularly after a specific period of time has passed. In an alternate embodiment the condition may specify that units of the digital asset are created on a given event, such as but not limited to: an addition of a block to the blockchain, an addition of data to the database, an input of data from an external event.

Through the embodiments detailed above a digital asset may be created in a database with associated quantities, ownership, and issuance conditions, and details of the digital asset may be propagated to other databases.

In a further embodiment of the preferred embodiment, when computer instructions are executed on the one or more processors of the one or more of the plurality of network connected devices, operations may be caused for transferring digital assets.

Operations for transferring digital assets may commence by a one of the plurality of network connected devices, henceforth referred to as a “sender”, inserting a transfer record into a database. The transfer record may, in one embodiment, comprise one or more of: a quantity of the digital asset, an owner of the digital asset, a receiver for the digital asset, an authorization for a transfer of the digital asset from the owner to the receiver.

Subsequently, a connective component of the sender may detect a presence of the transfer record, and may generate an asset transfer transaction. The asset transfer transaction may comprise some or all of the transfer record.

Operations may then proceed by a one or more of the remainder of the plurality of network connected devices, acting as validators, verifying that the asset transfer transaction is valid.

On successful verification the one or more of the plurality of network connected devices may add the asset transfer transaction to the blockchain, as described above in a definition of validators.

Subsequently, a second connective component of a second of the plurality of network connected devices, which in an embodiment may comprise: a second network connectivity module, a second connective component, and a second database, may retrieve the asset transfer transaction from the blockchain.

The second connective component may then generate a corresponding asset transfer record comprising some or all of the asset transfer transaction.

The second connective component may then insert the corresponding transfer record into the second database.

For the purposes of this disclosure an embodiment for tracking balances is described in terms of a third network connected device comprising a third connective component and a third database. However, those skilled in the art will appreciate from these teachings that the embodiment may be generalized to a system with a plurality of network connected devices, each with an own associated database and an own connective component, that may embody a tracking of balances wherein each one of the plurality of network connected devices may record a same balance for a given digital asset and for each owner.

In the embodiment, the third network connected device may record and update a balance sheet for the digital asset. The balance sheet may comprise a database table or a database record in the third database, comprising a one or more balance records of a one or more owners of a one or more digital assets.

Subsequently, the third network connected device may retrieve, through the third connective component, the asset transfer transaction from the blockchain.

The third network connected device may then determine a change to the one or more balance records.

The third network connected device may then alter contents of the balance sheet by, for example, updating, adding or deleting information from the one or more balance records, based on a calculation performed using information contained in the asset transfer transaction.

In a further embodiment of the invention, the asset transfer record may further comprise one or more of: a plurality of quantities, a plurality of owners, a plurality of receivers.

In yet another embodiment the asset transfer record may further comprise a plurality of authorizations, and the successful validation may comprise a further successful validation of each of the plurality of authorizations by a given number of the plurality of network connected devices. The given number may comprise one or more of: a percentage of the plurality of authorizations, a fixed number of the plurality of authorizations, a majority of the plurality of authorizations, or all of the plurality of authorizations.

In another embodiment, the asset transfer record may further comprise one or more of: a message, a time stamp, a validity period of the asset transfer record, a checksum of some or all of the transfer record.

Through these various embodiments detailed above, the digital asset is created through a medium of a database, and is propagated to other databases through the blockchain. The blockchain ensures that there is a single view of the balance and ownership of the digital asset, and other parties on the blockchain are able to determine balances and update a state of each database associated with each party to reflect the single view within each database.

Those skilled in the art will further appreciate the advantages and superior features found in this disclosure together with other important aspects thereof on reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 illustrates a peer-to-peer network with a plurality of network connected devices connected to the peer-to-peer network, performing the roles of a validator, an asset generator, an asset transferrer, and an asset receiver, maintaining and extending a blockchain, in accordance with an embodiment of the present disclosure.

FIG. 2A illustrates a network connected device and associated components that may function as the asset generator, the asset transferrer, or the asset receiver, in accordance with an embodiment of the present disclosure.

FIG. 2B illustrates a network connected device and associated components that may function as the validator, in accordance with an embodiment of the present disclosure.

FIG. 3 is a block diagram illustrating a structure of a possible embodiment of an asset creation record within a database, in accordance with an embodiment of the present disclosure.

FIG. 4 is a block diagram illustrating a structure of a possible embodiment of an asset creation message, in accordance with an embodiment of the present disclosure.

FIG. 5 is a block diagram illustrating a structure of a possible embodiment of an asset transfer record, in accordance with an embodiment of the present disclosure.

FIG. 6 is a block diagram illustrating a structure of a possible embodiment of an asset transfer transaction, in accordance with an embodiment of the present disclosure.

FIG. 7 is a diagram providing a general overview of a method and apparatus for generating a digital asset and propagating information concerning the digital asset, in accordance with an embodiment of the present disclosure.

FIG. 8 is a diagram presenting a process and system for creating and submitting an asset creation message, in accordance with an embodiment of the present disclosure.

FIG. 9 is a diagram presenting a process for verification of an asset creation message, in accordance with an embodiment of the present disclosure.

FIG. 10 is a diagram providing a general overview of a method and apparatus for transmitting a transaction of a digital asset and propagating information concerning a change in ownership of the digital asset, in accordance with an embodiment of the present disclosure.

FIG. 11 is a diagram presenting a process for creating an asset transfer transaction, in accordance with an embodiment of the present disclosure.

FIG. 12 is a diagram presenting a process for verification and processing an asset transfer transaction, in accordance with an embodiment of the present disclosure.

FIG. 13 is a block diagram illustrating a structure of a possible embodiment of a balance record, in accordance with an embodiment of the present disclosure.

FIG. 14 is a flowchart illustrating the updating of a balance of a digital asset in a balance record, in accordance with an embodiment of the present disclosure.

### DETAILED DESCRIPTION

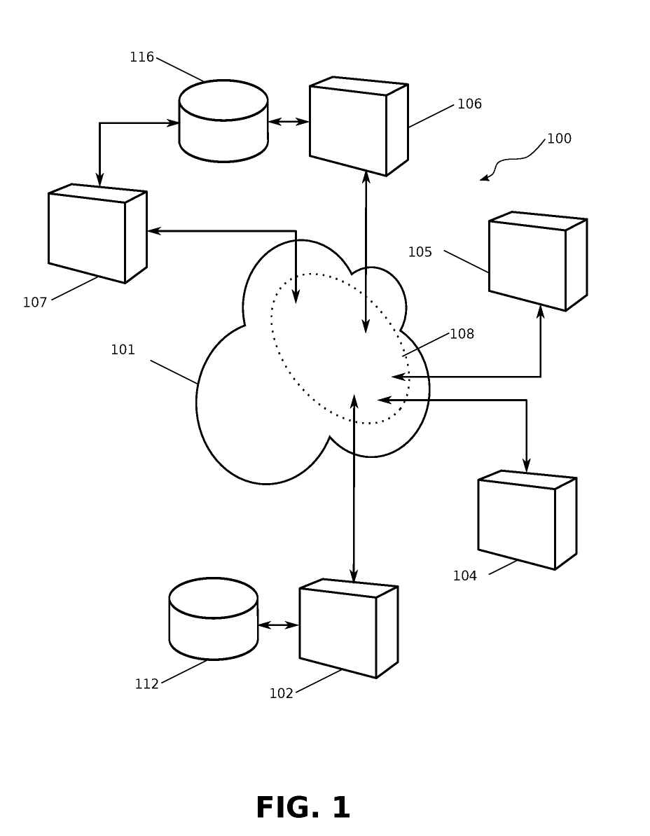

Aspects of this disclosure will be described in the context of an exemplary system 100 of a plurality of network connected devices communicating through the medium of a peer-to-peer network system 108, thereby implementing a blockchain, as shown schematically in FIG. 1.

As depicted, a peer-to-peer network 108 is embodied within a packet switched network 101, through the interconnection of the plurality of network connected devices on the peer-to-peer network 108.

Devices connected to the peer-to-peer network 108 may comprise a database, for example a network connected device 102 and associated database 112, that may generate digital assets.

Other devices connected to the peer-to-peer network 108 may include network connected devices acting as communication nodes, for example network connected device 104 whose role is to maintain a list of other devices connected through the peer-to-peer network, and to forward on received network messages to those devices on the list, possibly independently, or possibly as a response to a request from another network connected device. As one skilled in the art will be aware, no individual communication node is required to have a complete list of all devices, as the process of peer-to-peer networking only requires that a union of a set of all communication nodes contains a complete list of all devices on the peer-to-peer network, and for every pair of network connected devices there is a network route from one device to the other, possibly via a set of one or more nodes. Therefore, the only requirement to be a participant on the peer-to-peer network is to establish a connection to one or more of the communication nodes on said network.

Further devices connected via the peer-to-peer network 108 may include blockchain validators, for example network connected device 105, acting as a validator node or “miner”, whose role may be to act as a communication node, and may also be to receive messages, records and other transaction or data messages from the peer-to-peer network 108, process them, and transmitting the results of said processing back to the peer-to-peer network 108 for potential inclusion in the blockchain.

Further devices connected via the peer-to-peer network 108 may include other participants on the peer-to-peer network tracking and recording a generation of digital assets, and a submission of asset transfer transactions, for example a network connected device 106, and an associated database 116. In another embodiment a further network connected device 107 may share the associated database 116.

The devices described above may be implemented through a system comprising a one or a plurality of: a general purpose microprocessor, a digital signal processor (DSP), an application specific instruction set processor (ASIP), a field programmable gate array (FPGA), a dedicated application specific integrated chip (ASIC), or other equivalent integrated or discrete logic circuitry and peripheral circuitry, connected to a tangible storage medium containing instructions which when executed effect methods and techniques described below. The techniques additionally, or alternatively, may be realized at least in part by a computer-readable communication medium or record carrier, that carries or communicates code in the form of instructions or data structures and that can be accessed, read, and/or executed by a computer.

The devices described above may connect to the peer-to-peer network 108 through a direct connection to the packet switched network 101 with a wired connection, or through a wireless connection by association with a wireless access point, a cellular base station, a Bluetooth connection, or other means of connection.

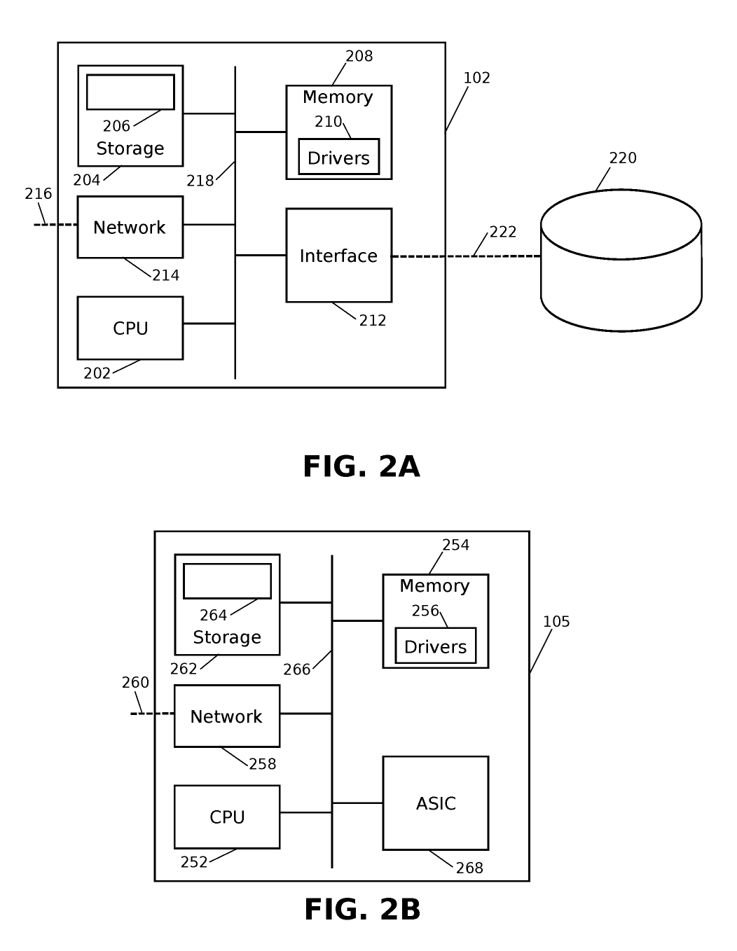

An embodiment of the network connected device 102 is presented in FIG. 2A, and is now discussed in further detail. The network connected device 102 may comprise a one or more central processing units (CPU) 202 capable of executing instructions stored in a memory 208, and controlling other peripheral components through drivers 210 stored within the memory 208.

Further storage 204 may be present, which may comprise a cryptographically secure partition 206 comprising a component where cryptographic keys may be securely stored.

The network connected device 102 may comprise a network module 214, which may consist of a direct wired connection to a packet switched network through a cable 216.

In other embodiments the network module 214 may comprise wireless components comprising one or more wireless modules implemented in firmware or hardware, including a wireless local area network (WLAN) unit such as a Wi-Fi adapter utilizing an 802.11 protocol, a wireless wide area network (WWAN) unit such as Global System for Mobile communications (GSM), Long Term Evolution (LTE), or other cellular wireless data communication system. The wireless components may provide network connectivity to a packet switched network and hence to the peer-to-peer network for the network connected device 102.

In other embodiments the network module 214 may comprise wireless components comprising one or more Bluetooth modules implemented in firmware or hardware. The Bluetooth components may provide network connectivity to a packet switched network and hence to the peer-to-peer network for the network connected device 102.

Components comprising the network connected device 102 may communicate through a bus 218, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

The network connected device 102 may comprise a database 220. The database 220 may be instantiated internally to the network connected device 102, or it may comprise an instantiation on a separate device or machine communicated to through an external connection 222 and an interface 212 within the network connected device. The external connection may be a cable to a packet-switched network, either on a local area network or wide area network, an external serial connection, or through a wireless connection by association with a wireless access point, a cellular base station, a Bluetooth connection, or other means of connection.

An embodiment of the network connected device 105 acting as a blockchain validator, is detailed in FIG. 2B,

The network connected device 105 may may comprise a one or more central processing units (CPU) 252 capable of executing instructions stored in a memory 254, and controlling other peripheral components through drivers 256 stored within the memory 254.

Further storage 262 may be present, which may comprise a cryptographically secure partition 264 or component where cryptographic keys may be securely stored.

The network connected device 105 may comprise a network module 258, which may consist of a direct wired connection to a packet switched network through a cable 260 or through a wireless connection to a wireless local area network (WLAN) unit such as a Wi-Fi adapter utilizing an 802.11 protocol, a wireless wide area network (WWAN) unit such as Global System for Mobile communications (GSM), Long Term Evolution (LTE), or other cellular wireless data communication system.

Components comprising the network connected device 105 may communicate through a bus 266, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

The network connected device 105 may also comprise a hardware component 268, which in some embodiments may be implemented as an ASIC. The hardware component 268 may implement components in hardware for accelerating an execution of algorithms pertaining to a maintenance and extension of the blockchain, for example a SHA256 hashing component for executing proof of work calculations.

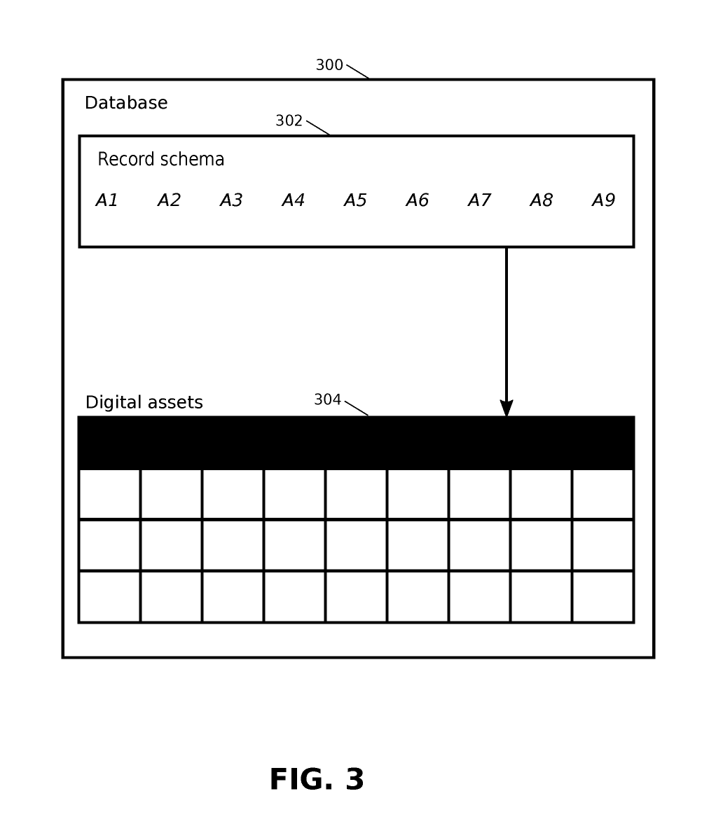

In FIG. 3 an embodiment of an asset creating record is presented, through which network connected device 102 may record data comprising a digital asset for instantiating on the blockchain.

The asset creation record may be instantiated in a database 300.

The database 300 may comprise a record schema 302, which may specify data fields and associated data structures defining a structure for the asset creation record.

In a preferred embodiment of the present disclosure, schema element A1 may comprise a string, representing a human readable identifier of a digital asset. Schema element A2 may comprise an integer, representing a digital identifier for the digital asset. Schema element A3 may comprise an integer representing a total quantity of the digital asset that may be generated. Schema element A4 may comprise an integer, representing an initial quantity of the digital asset that may be generated on creation of the digital asset. Schema element A5 may comprise a floating point number or a fixed point number, representing a generation rate for the digital asset. In one embodiment the generation rate may comprise a time period after which a further quantity of the digital asset may be issued. Schema element A6 may comprise a time, representing a creation time for the digital asset. Schema element A7 may comprise a string, representing an identifier for a creator of the digital asset. In an embodiment the identifier may comprise a name of the creator. In other embodiment the identifier may comprise: an email address, an IP address, a social security number, a public key of an asymmetric cryptographic key pair, a passport number, an other form of identifier. Schema element A8 may comprise a data structure representing a one or more mathematical functions for determining an asset generation rate and quantity over time. For example, a function may be an exponential decay, and the quantity of the digital asset generated over time may decrease in accordance with said function. Schema element A9 may comprise a time, and may represent a time at which the asset creation record is added to the database 300.

It will be apparent to those skilled in the art that an aforementioned schemas A1 . . . A9 represent one of a number of similar representation that may be defined to implement the current disclosure. Furthermore, an order in which the aforementioned schemas are presented may be rearranged with no loss of generality.

In some embodiments, the database 300 may comprise a digital assets database table 304, a structure of the digital assets database table defined by the record schema 302. In other embodiments the records of digital assets may be stored in a schemaless database, wherein each record defines the structure of the data.

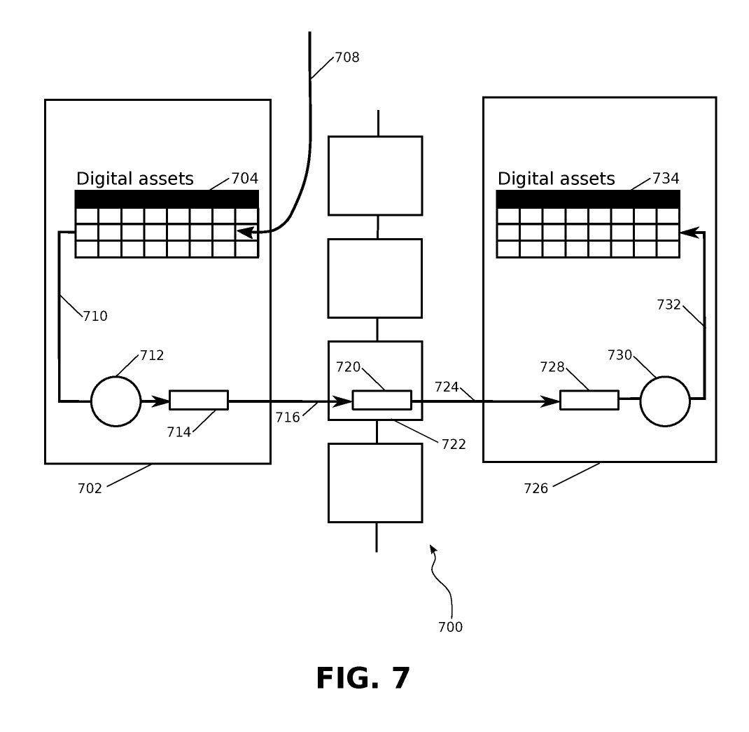

A new digital asset may then be instantiated by adding a record to the digital assets database table 304, as is further elucidated below, for example in a description of FIG. 7.

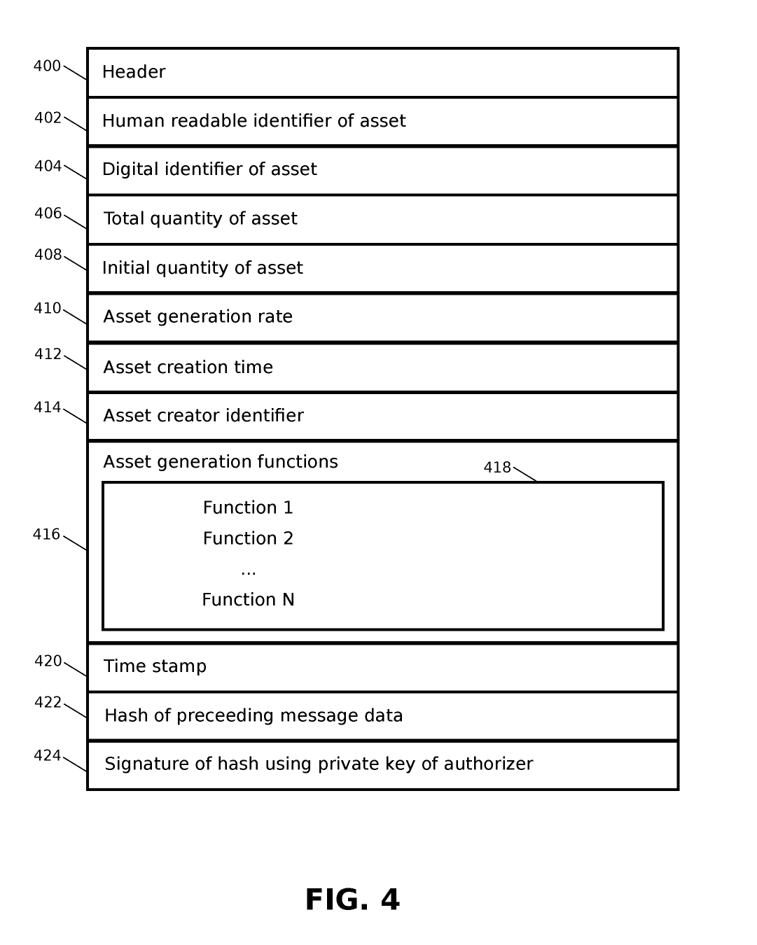

FIG. 4 presents an embodiment of an asset creation message generated from a record in the digital assets database table.

The asset creation message may comprise a header 400, which may comprise: an identifier indicating that the asset creation message contains asset creation data, a size of the asset creation message, a protocol for the asset creation message, a structure of other data comprising the asset creation message.

The asset creation message may comprise a human readable identifier 402 of the digital asset to create. The human readable identifier 402 may be stored as a string, and may comprise a one or more words in a human language.

The asset creation message may comprise a digital identifier 404 of the digital asset to create. The digital identifier 404 may be stored as a string or as an integer, or as some other data structure. In some embodiments it may comprise a unique identifier for the digital asset. In other embodiments it may comprise: a unique identification number, a cryptographic key, a combination of digits and characters.

The asset creation message may comprise a total quantity 406 of the digital asset to create. The total quantity 406 may set an upper limit for the number of units of the digital asset that may be instantiated. In an other embodiment a number of decimal places specified may set the divisibility of the digital asset, that is, the smallest fractional unit of the digital asset that may be transferred as a single entity.

The asset creation message may comprise an initial quantity 408 of the digital asset. The initial quantity 408 may specify how many units of the digital asset may be created at a start of an asset creation period.

The asset creation message may comprise an asset generation rate 410 of the digital asset. The asset generation rate may specify how many units of the digital asset may be created in: a given period of time, a given number of blockchain blocks.

The asset creation message may comprise an asset creation time 412 for the digital asset to create. In an embodiment the asset creation time 412 may indicate a past time after which the digital asset is considered to be in existence. In another embodiment the asset creation time 412 may comprise a future time, after which the digital asset may be considered to exist. Prior to said asset creation time, transactions comprising transfers of the digital asset may be considered invalid by validators on the blockchain.

The asset creation message may comprise an asset creator identifier 414. In an embodiment the asset creator identifier 414 may comprise one or more of: an email address, a name, a digital identifier, a public cryptographic key. Through the asset creator identifier other parties may determine the identity of a party that created the digital asset.

The asset creation message may comprise a one or more asset generation functions 416 of the digital asset. The one or more asset generation functions 416 may be enumerated in a list 418, said list providing a set of mathematical functions and associated valid time periods for an each member of the set of mathematical functions, or in another embodiment, valid block ranges within the blockchain for each member of the set of mathematical functions. In an embodiment, an asset generation function may provide further details for the asset generation rate, for example by providing an exponential decay to a quantity of digital asset generated over a given period of time. In a different embodiment, an asset generation function may provide a specification for a proof-of-work problem or cryptographic puzzle that may be solved in order to generate more units of the digital asset.

The asset creation message may comprise a time stamp 420. In an embodiment the time stamp may comprise a time at which the asset creation message was constructed. The asset creation message may also comprise a plurality of time stamps.

The asset creation message may comprise a hash of all or part of a preceding asset creation message contents 422. The hash may be calculated using a cryptographic hash algorithm, for example: SHA, RIPEMD, Whirlpool, Scrypt, HAS-160, BLAKE, or other cryptographic hash function applied to all or part of the preceding content of the message, where a hash output cannot be determined from a hash input other than by an application of the cryptographic hash function to the hash input.

The asset creation message may also comprise a digital signature 424, generated with a digital signature algorithm using a private key associated with the asset creator identifier 414 and the hash 422, in order to provide for the veracity of the asset creation message. The digital signature algorithm used may be one of ECDSA, DSA, RSA, or some other digital signing algorithm.

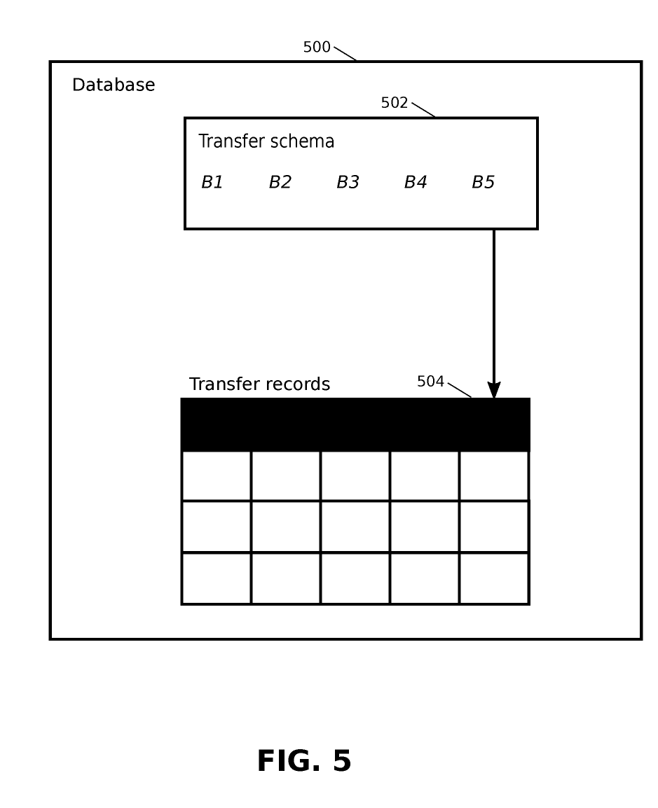

In FIG. 5 an embodiment of a transfer record is presented, through which a network connected device, for example network connected device 102, may record data comprising a transfer of a quantity of a digital asset from a sender to a receiver, for execution on the blockchain.

The transfer record may be instantiated in a database 500.

The database 500 may comprise a record schema 502, which may specify data fields and associated data structures defining a structure for the transfer record.

In a preferred embodiment of the present disclosure, schema element B1 may comprise a string, representing a human readable identifier of a digital asset. Schema element B2 may comprise an integer, representing a digital identifier for the digital asset. Schema element B3 may comprise a data structure, comprising a list of digital identifiers that may identify current owners of the digital asset. Schema element B4 may comprise a floating point number or a fixed point number, representing a quantity of the digital asset to transfer. Schema element B5 may comprise a data structure, for example a list of tuples in a preferred embodiment, in which a first element of each tuple may comprise a digital identifier of a receiver or recipient of the digital asset, and a second element of each tuple may comprise a floating point number or a fixed point number, representing a quantity of the digital asset to transfer to said receiver or recipient.

In an embodiment each identifier may comprise: an email address, an IP address, a social security number, a public key of an asymmetric cryptographic key pair, a passport number, an other form of identifier.

It will be apparent to those skilled in the art that an aforementioned schemas B1 . . . B5 represent one of a number of similar representations that may be defined to implement the current disclosure. Furthermore, an order in which the aforementioned schemas are presented may be rearranged with no loss of generality.

In some embodiments, the database 500 may comprise a transfer records database table 504, a structure of the transfer records database table defined by the record schema 502. In other embodiments the records of digital assets may be stored in a schemaless database, wherein each record defines the structure of the data.

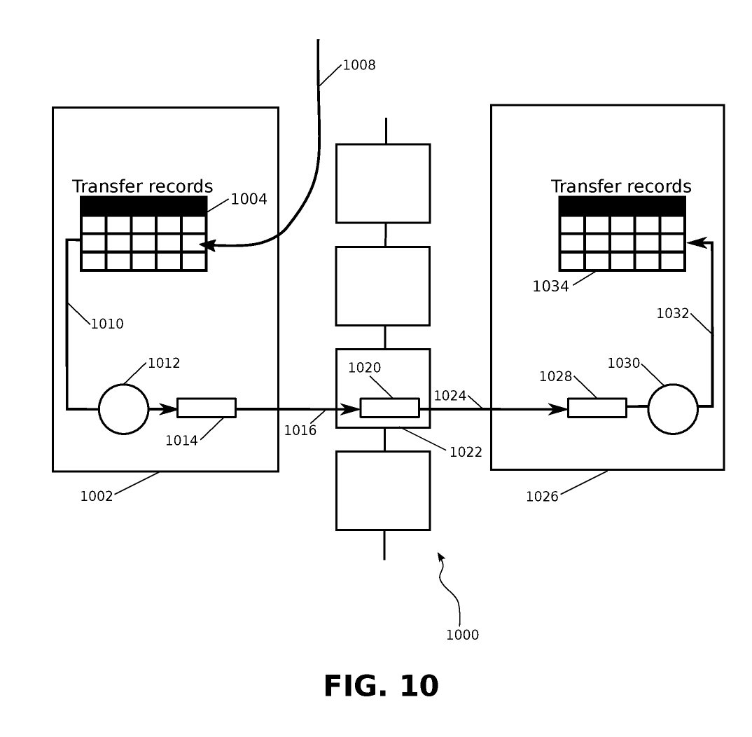

A new digital asset transfer may then be instantiated by adding a record to the transfer records database table 504, as is further elucidated below, for example in a description of FIG. 10.

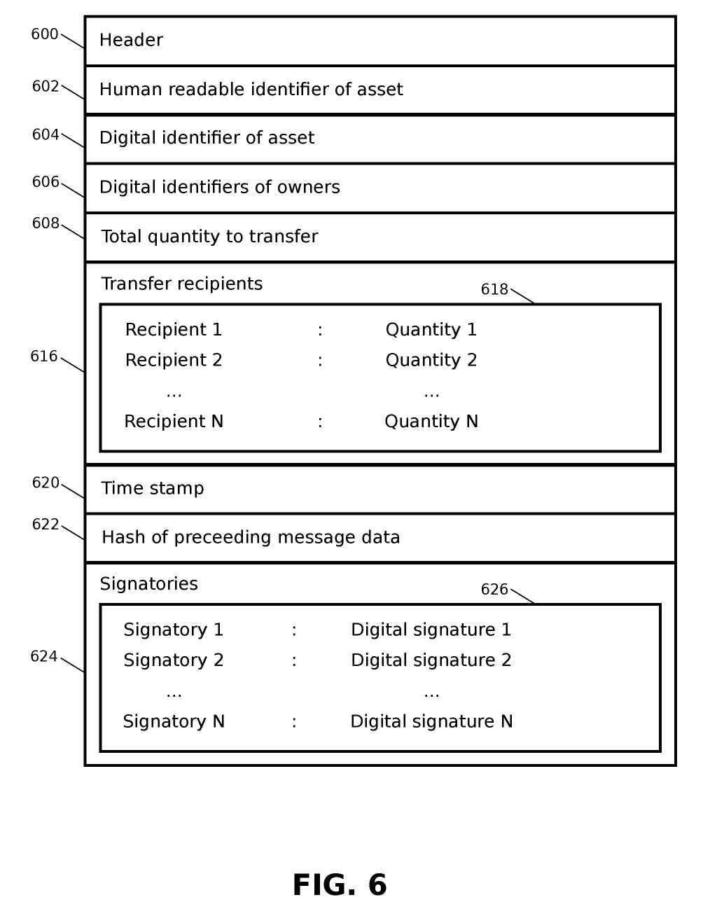

FIG. 6 presents an embodiment of an asset transfer message generated from a record in the transfer records database table.

The asset transfer message may comprise a header 600, which may comprise: an identifier indicating that the asset transfer message contains asset transfer data, a size of the asset transfer message, a protocol for the asset transfer message, a structure of other data comprising the asset transfer message.

The asset transfer message may comprise a human readable identifier 602 of the digital asset to transfer. The human readable identifier may be stored as a string, and may comprise a one or more words in a human language. In the preferred embodiment the content of the human readable identifer 602 may be extracted from a transfer record field corresponding to transfer schema B1.

The asset transfer message may comprise a digital identifier 604 of the digital asset to transfer. The digital identifier may be stored as a string or as an integer, or as some other data structure. In some embodiments it may comprise a unique identifier string for the digital asset. In other embodiments it may comprise: a unique identification number, a cryptographic key, a combination of digits and characters. In the preferred embodiment a content of the digital identifier 604 may be extracted from a transfer record field corresponding to transfer schema B2.

The asset transfer message may comprise a list of digital identifiers of digital asset owners 606. In the preferred embodiment a content of the list of digital identifiers of digital asset owners 606 may be extracted from a transfer record field corresponding to transfer schema B3.

The asset transfer message may comprise a total quantity 608 of the digital asset to transfer. The total quantity may set an upper limit for the number of units of the digital asset that may be transferred. In the preferred embodiment a content of the total quantity 608 may be extracted from a transfer record field corresponding to transfer schema B4.

The asset transfer message may comprise a list of digital identifiers of transfer recipients 616. In the preferred embodiment the content of the list of transfer recipients 616 may be extracted from a transfer record field corresponding to transfer schema B5. In a further embodiment the list of digital identifiers of transfer recipients 616 may comprise a list of tuples 618, in which a first element of each tuple may comprise a digital identifier of a receiver or recipient of the digital asset, and a second element of each tuple may comprise a floating point number or a fixed point number, representing a quantity of the digital asset to transfer to said receiver or recipient.

The asset transfer message may comprise a time stamp 620. In an embodiment the time stamp may comprise a time at which the asset transfer message was constructed. In another embodiment the time stamp 620 may comprise a time from which point on the asset transfer message may be valid. In yet another embodiment the time stamp 620 may comprise a time after which the asset transfer message may no longer be valid if not executed beforehand. The asset transfer message may also comprise a plurality of time stamps.

The asset transfer message may comprise a hash 622 of all or part of a preceding asset transfer message contents. The hash 622 may be calculated using a cryptographic hash algorithm, for example: SHA, RIPEMD, Whirlpool, Scrypt, HAS-160, BLAKE, or other cryptographic hash function applied to all or part of the preceding content of the message, where a hash output cannot be determined from a hash input other than by an application of the cryptographic hash function to the hash input.

The asset transfer message may also comprise a list of signatories 624. In a preferred embodiment the list of of signatories may comprise a list of tuples 626, in which a first element of each tuple may comprise a digital identifier of an owner of the digital asset, and a second element of each tuple may comprise a digital signature generated using the digital identifier of the first element and using a digital signature algorithm using a private key associated with the the digital identifier and the hash 622, in order to provide for the veracity of the asset transfer message. The digital signature algorithm used may be one of ECDSA, DSA, RSA, or some other digital signing algorithm.

Those skilled in the art will appreciate that embodiments above of the asset transfer message and the transfer record are examples of possible embodiments. In other embodiments of each, records may comprise elements in a different order, elements may be combined or separated differently, and each record may comprise further elements.

In FIG. 7 a possible embodiment of an apparatus for generating a digital asset and propagating information concerning the digital asset to other interested parties, is presented.

In the embodiment a blockchain 700 may form the communication channel between two interested parties, namely a digital asset generator 702 and an other interested party using a network connected device 726 to receive data and information concerning the digital asset.

In this preferred embodiment, operations may commence by an external agency inserting a new record into a database table of digital assets 704. In FIG. 7 an action of inserting the new record is indicated by by 708. The new record may comprise an asset creation record.

The digital asset generator 702 may comprise a connective component 712 that monitors the database table of digital assets 704 for an appearance of the new record. On detecting the new record the connective component may extract data from the new record, which in some embodiments may comprise the asset creation record, and may construct an asset creation message 714. In FIG. 7 an extraction of data from the new record is indicated by 710.

The digital asset generator 702 may then transmit the asset creation message 714 to the blockchain 700. An action of transmitting the asset creation message 714 is indicated in FIG. 7 by 716.

Validators on the blockchain 700 may then verify that the asset creation message 714 is valid, and may include a copy of the asset creation message 720 in a block 722. Said block 722 may then be included or appended to the blockchain 700.

The network connected device 726 may then detect a presence of the block 722 and may proceed by extracting the copy of the asset creation message 720 from the block 722, resulting in a local copy of the asset creation message 728. An action of extracting the copy of the asset creation message 720 is indicated in FIG. 7 by 724.

The network connected device 726 may comprise a second connective component 730. The second connective component 730 may extract a data from the local copy of the asset creation message 728 and may use the data to construct a second asset creation record. The second connective component may then insert the second asset creation record into a second database table of digital assets 734. An action of inserting the second asset creation record is indicated in FIG. 7 by 732.

Through the actions described above, a digital asset defined in a database on one device, namely the digital asset generator 702 may be propagated across a blockchain and become visible in a second database on a second device, namely the network connected device 726.

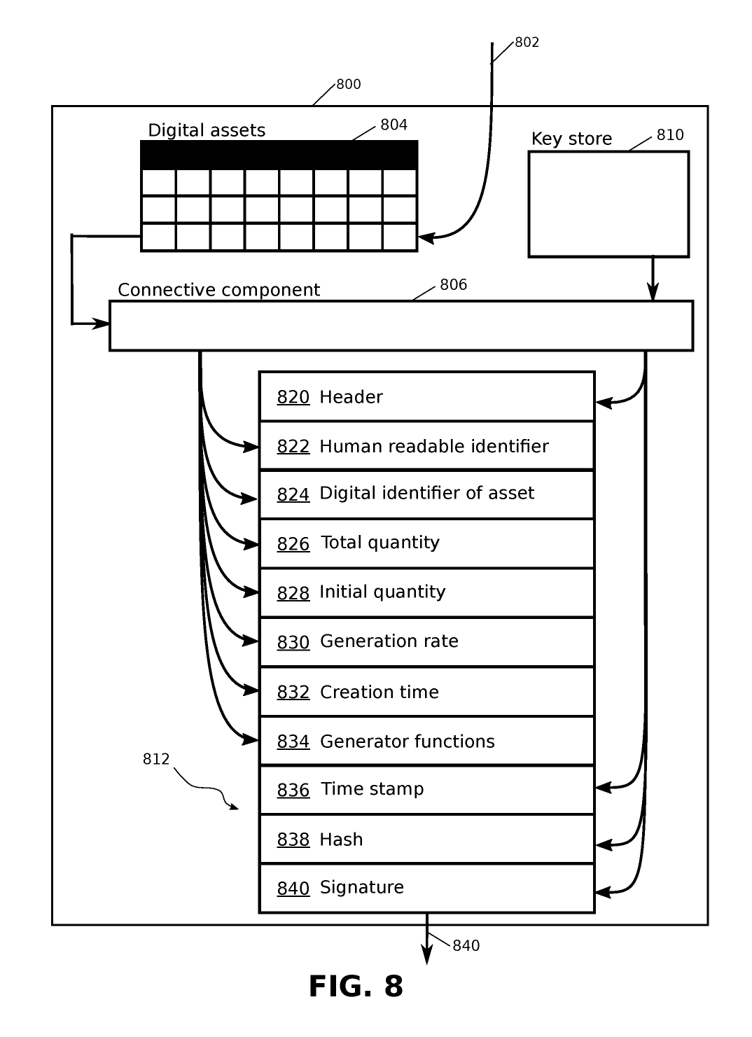

In FIG. 8 we now turn to a more detailed examination of how a digital asset generator 800 comprising a connective component 806 may generate an asset creation message from an asset creation record.

As described before in FIG. 7, in FIG. 8 actions may commence by an external entity inserting an asset creation record into a digital assets database table 804, as indicated by 802. The asset creation record may, in some embodiments, be copied from an other one or more database records, or it may be created by a human user through a filling in and submission of a web page form, or through other interface software. In other embodiments other software may gather a data and transform said data into a database record for insertion, for example through an SQL INSERT command, or through insertion of a data structure.

The connective component 806 may then detect a new record in the digital assets database table 804, and may extract data from the new record.

The connective component 806 may extract a human readable identifier 822 from the new record and add it to an asset creation message 812.

The connective component 806 may extract a digital identifier of the digital asset 824 from the new record and add it to the asset creation message 812.

The connective component 806 may extract a total quantity of the digital asset 826 from the new record and add it to the asset creation message 812.

The connective component 806 may extract an initial quantity of the digital asset 828 from the new record and add it to the asset creation message 812.

The connective component 806 may extract a generation rate for the digital asset 830 from the new record and add it to the asset creation message 812.

The connective component 806 may extract a creation time 832 from the new record and add it to the asset creation message 812.

The connective component 806 may extract a list of generator functions 834 from the new record and add it to the asset creation message 812.

All the aforementioned extractions from the new record have previously been described in the detailed description of FIG. 5.

The connective component 806 may construct a header 820 for the the asset creation message 812, as per the header 400 (FIG. 4).

The connective component 806 may add a time stamp 836 to the asset creation message 812, as per the time stamp 420 (FIG. 4).

The connective component 806 may calculate a hash 838 from some or all of a preceding message components, and may append said hash 838 to the asset creation message 812, as previously described for the hash 422 (FIG. 4).

The connective component 806 may retrieve a private key of a public/private key pair from a key store 810 or other secure storage, and may produce and attach a signature 840 to the asset creation message. The signature 840 may comprise digitally signing the hash 838 with the private key using a digital signature algorithm, for example the digital signature algorithm may be one of ECDSA, DSA, RSA, or some other digital signing algorithm. In an embodiment a public key of the public/private key pair may comprise or may be derived from an identifier associated with the external entity. In an embodiment the signature 840 may also comprise the public key.

The digital asset generator 800 may then submit the asset creation message 812 over a network to a blockchain, as indicated in FIG. 8 by 840.

Those skilled in the art will appreciate that in the embodiment above, for illustrative purposes, a specific example of a message construction has been presented. In other examples a number of components added to the asset creation message may differ, said number of components may comprise different or alternate contents, and other actions and steps may be taken in a different order.

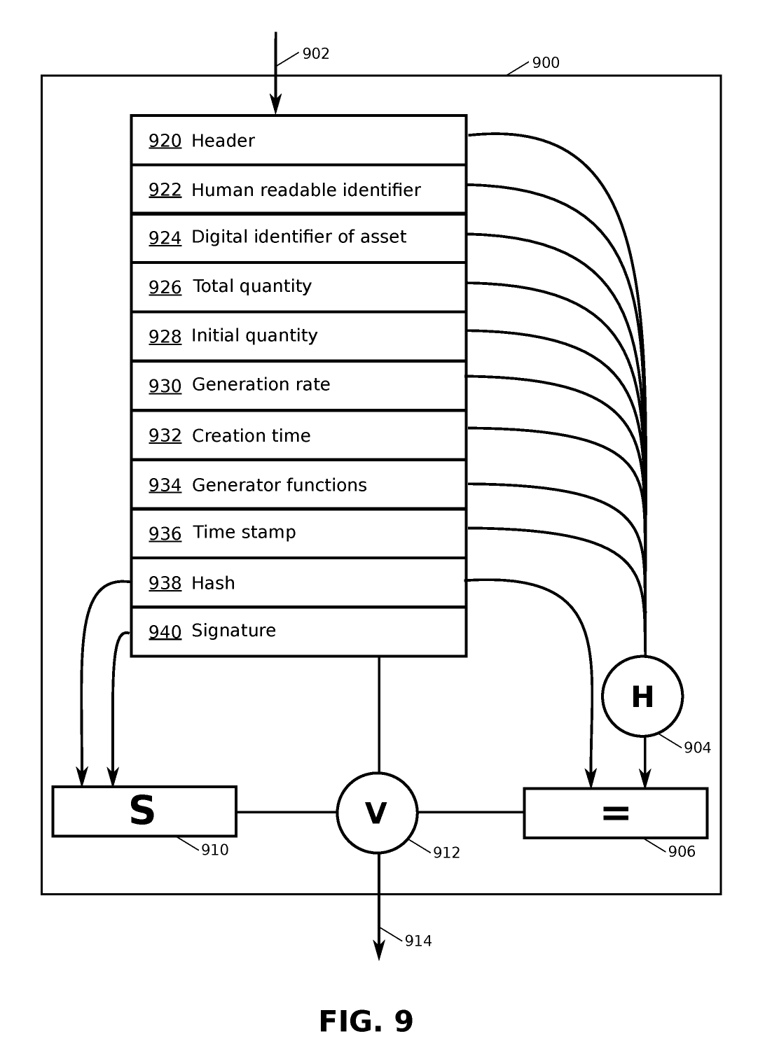

In FIG. 9 an embodiment of a possible component of the present disclosure for verifying the validity of an asset creation message is presented. In the embodiment, a network connected device 900 may retrieve an asset creation message from a blockchain, as indicated by 902.

The network connected device 900 may then extract from the asset creation message a block of digital data comprising one or more of a header 920, a human readable identifier 922, a digital identifier of the digital asset 924, a total quantity of the digital asset 926, an initial quantity of the digital asset 928, a generation rate 930, a creation time 932, a list of generator functions 934, and a time stamp 936.

The network connected device 900 may then calculate a hash of the block of digital data using a hash function 904.

The network connected device 900 may extract a hash 938 from the the asset creation message, and may compare said hash 938 with the hash of the block of digital data using a comparison function 906. If a comparison shows the hash 938 and the hash of the block of digital data are equal, the comparison function 906 may return a value of true to a verification function 912.

The network connected device 900 may extract the hash 938 and a signature 940 from the asset creation message, and may verify a validity of the signature 940 using a signature verification function 910. In an embodiment the signature verification function 910 may verify that the signature 940 correctly signs the hash 938 using, for example, a digital signature algorithm such as one of: ECDSA, DSA, RSA, or some other digital signing algorithm. The signature 940 may comprise a public key, and the signature verification function 910 may use the public key to verify the signature 940. In another embodiment the public key may be obtained by the network connected device 900 by extracting it from a previous block on the blockchain, through an out-of-band transfer between the digital asset generator and the network connected device 900, or through some other method.

If the signature verification function 910 determines that the signature 940 is valid, the signature verification function 910 may return a value of true to a verification function 912.

If the verification function 912 receives a value of true from both the signature function 910 and the comparison function 906, the verification function 912 may pass the asset creation message onward to an other component of the network connected device 900 for further processing, as is shown in FIG. 9 by element 914.

FIG. 10 presents a possible embodiment of an apparatus for generating a digital asset transfer and propagating information concerning the digital asset transfer to other interested parties.

In the embodiment a blockchain 1000 may form the communication channel between two interested parties, namely a digital asset transfer requester 1002 and an other interested party using a network connected device 1026 to receive data and information concerning the digital asset and a transfer of digital asset quantities between different parties.

In this preferred embodiment, operations may commence by an external agency inserting a new record into a database table of transfer records 1004. In FIG. 10 an action of inserting the new record is indicated by by 1008. The new record may comprise an asset transfer record.

The digital asset transfer requester 1002 may comprise a connective component 1012 that monitors the database table of transfer records 1004 for an appearance of the new record. On detecting the new record the connective component may extract data from the new record, which in some embodiments may comprise the transfer record, and may construct an asset transfer message 1014. An extraction of data from the new record is indicated in FIG. 10 by 1010.

The digital asset generator 1002 may then transmit the asset transfer message 1014 to the blockchain 1000. An action of transmitting the asset transfer message 1014 is indicated in FIG. 10 by 1016.

Validators on the blockchain 1000 may then verify that the asset transfer message 1014 is valid, and may include a copy of the asset transfer message 1020 in a block 1022. Said block 1022 may then be included or appended to the blockchain 1000.

The network connected device 1026 may then detect a presence of the block 1022 and may proceed by extracting the copy of the asset creation message 1020 from the block 1022, resulting in a local copy of the asset creation message 1028. An action of extracting and generating the copy of the asset creation message 1028 is indicated in FIG. 10 by 1024.

The network connected device 1026 may comprise a second connective component 1030. The second connective component 1030 may extract a data from the local copy of the asset creation message 1028 and may use the data to construct a second asset creation record. The second connective component 1030 may then insert the second asset creation record into a second database table of transfer records 1034. An action of inserting the second asset transfer record is indicated in FIG. 10 by 1032.

Through the actions described above, a transfer request for a digital asset from one party to one or more other parties, added to a database on one device, namely the digital asset transfer requester 1002, may subsequently be propagated across a blockchain and become visible in a second database on a second device, namely the network connected device 1026. As the blockchain 1000 provides verification of a validity of the transfer request, and presents an immutable record of the transfer request, trust is built in a reliability of a transfer of the digital assets.

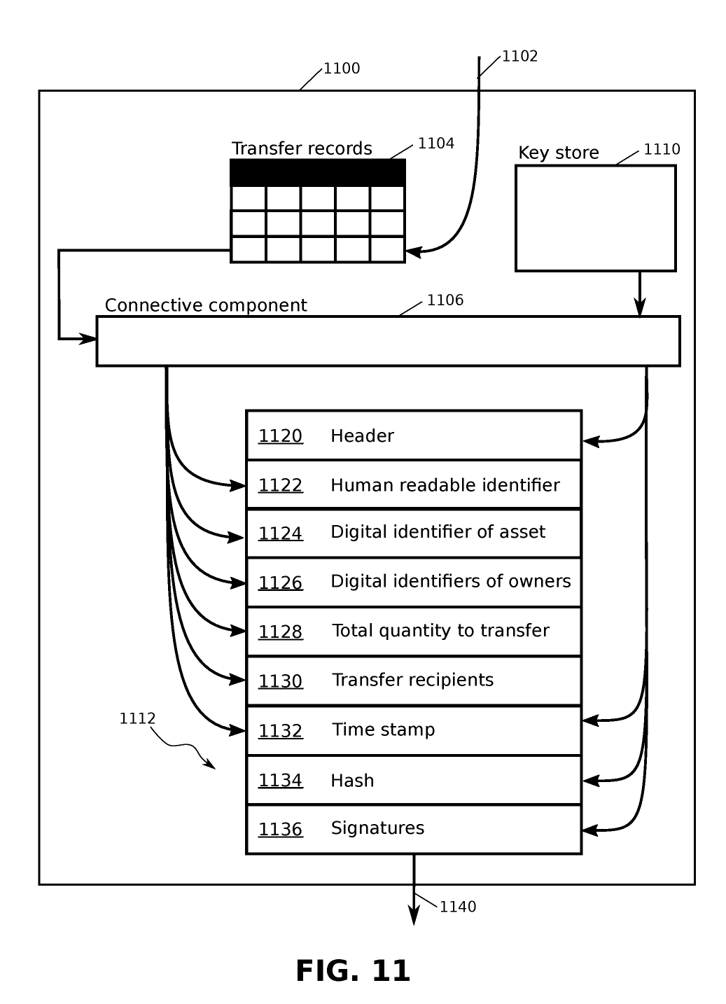

In FIG. 11 we now turn to a more detailed examination of how a digital asset transfer requester 1100 comprising a connective component 1106 may generate an asset transfer message from an asset transfer record.

As described before in FIG. 10, in FIG. 11 actions may commence by an external entity inserting an asset transfer record into a database table of transfer records 1104, as indicated by 1102. The asset transfer record may, in some embodiments, be copied from an other one or more database records, or it may be created by a human user through a filling in and submission of a web page form, or through other interface software. In other embodiments, other software may gather a data and transform said data into a transfer record for insertion, for example through an SQL INSERT command.

The connective component 1106 may then detect a new record in the database table of transfer records 1104, and may extract data from the new record.

The connective component 1106 may extract a human readable identifier 1122 from the new record and add it to an asset transfer message 1112.

The connective component 1106 may extract a digital identifier of the digital asset 1124 from the new record and add it to the asset transfer message 1112.

The connective component 1106 may extract a list of digital identifiers corresponding to a one or more owners of the digital asset 1126 from the new record and add it to the asset transfer message 1112.

The connective component 1106 may extract a total quantity of the digital asset to transfer 1128 from the new record and add it to the asset transfer message 1112.

The connective component 1106 may extract a list of digital identifiers corresponding to a one or more recipients of the digital asset 1130 from the new record and add it to the asset creation message 1112. In an embodiment the list of digital identifiers may comprise tuples, with each tuple comprising a digital identifier of a recipient, and a quantity of the digital asset to be transferred to the recipient.

The connective component 1106 may extract a time stamp 1132 from the new record and add it to the asset transfer message 1112. In an embodiment the time stamp 1132 may represent a time at which the asset transfer record was generated.

In a different embodiment the connective component 1106 may create the time stamp 1132 based on a time at which the connective component 1106 created the asset transfer message 1112.

The connective component 1106 may construct a header 1120 for the the asset transfer message 1112, as per a description for the header 600 (FIG. 6) above.

The connective component 1106 may calculate a hash 1134 from some or all of a preceding message components, and may append said hash 1134 to the asset transfer message 1112, as previously described for the hash 622 (FIG. 6) above.

The connective component 1106 may retrieve a one or more private keys of a one or more public/private key pairs from a key store 1110 or other secure storage, and may produce and attach a signature 1136 to the asset creation message. The signature 1136 may comprise digitally signing the hash 1134 with each of the one or more private keys using a digital signature algorithm. The digital signature algorithm may be one of ECDSA, DSA, RSA, or some other digital signing algorithm. In an embodiment a one or more public keys of the one or more public/private key pairs may comprise or may be derived from a one or more identifiers associated with the one or more owners of the digital asset 1126. In an embodiment the signature 1136 may also comprise a one or more public keys.

The digital asset transfer requester 1100 may then submit the asset transfer message 1112 over a network to the blockchain, as indicated in FIG. 11 by 1140.

Those skilled in the art will appreciate that in the embodiment above, for illustrative purposes, a specific example of an asset transfer message construction has been presented. In other examples a number of components added to the asset transfer message may differ, said number of components may comprise different or alternate contents, and other actions and steps may be taken in a different order.

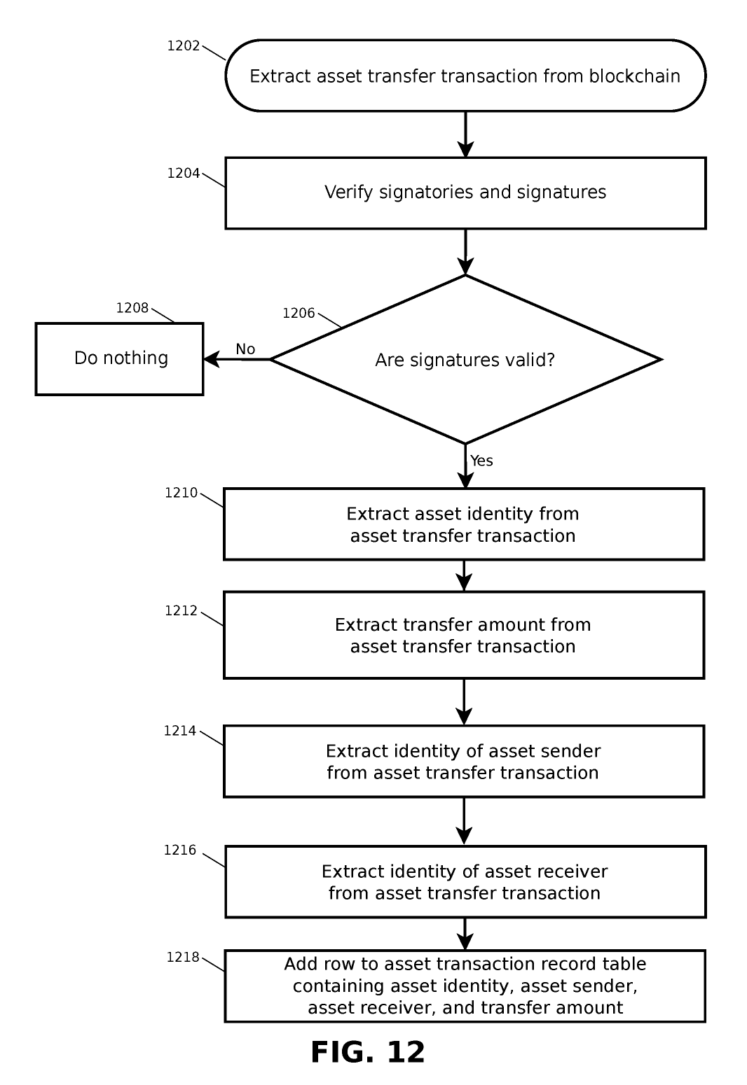

In FIG. 12 a process for verifying and processing an asset transfer transaction, in accordance with an embodiment of the present disclosure, is presented.

Operations may commence by extracting an asset transfer transaction from a block in the blockchain comprising an asset transfer message, as shown in step 1202.

As shown in step 1204, operations may proceed by a verification of a one or more signatories and a one or more associated signatures contained within the asset transfer transaction, producing a validity result.

In step 1026 the validity result is examined. If the validity result is false, operations may proceed to step 1208, the asset transfer transaction may be discarded, and operations may halt.

If the validity result is true, operations may proceed to step 1210.

In step 1210 an asset identity may be extracted from the asset transfer transaction.

In step 1212 a transfer amount for the digital asset may be extracted from the asset transfer transaction.

For clarity, in a current exemplary embodiment of the present disclosure, an asset transfer from an asset sender to an asset receiver is presented. On reviewing the present disclosure those skilled in the art will appreciate that in other embodiments the transaction may comprise a plurality of asset senders and/or a plurality of asset receivers, and under such other embodiments steps that follow may be conducted multiple times for each one of the plurality of asset senders and/or for each one of the plurality of asset receivers.

In step 1214 an identity of an asset sender may be extracted from the asset transfer transaction.

In step 1216 an identity of an asset receiver may be extracted from the asset transfer transaction.

Finally, in step 1218 a record of data, comprising an asset record, may be added to an asset transaction record table in a database, said record of data comprising the asset identity, the identity of the asset receiver, the identity of the asset receiver, and the transfer amount. In other embodiments the signatories and the signatures may also be included in the asset record.

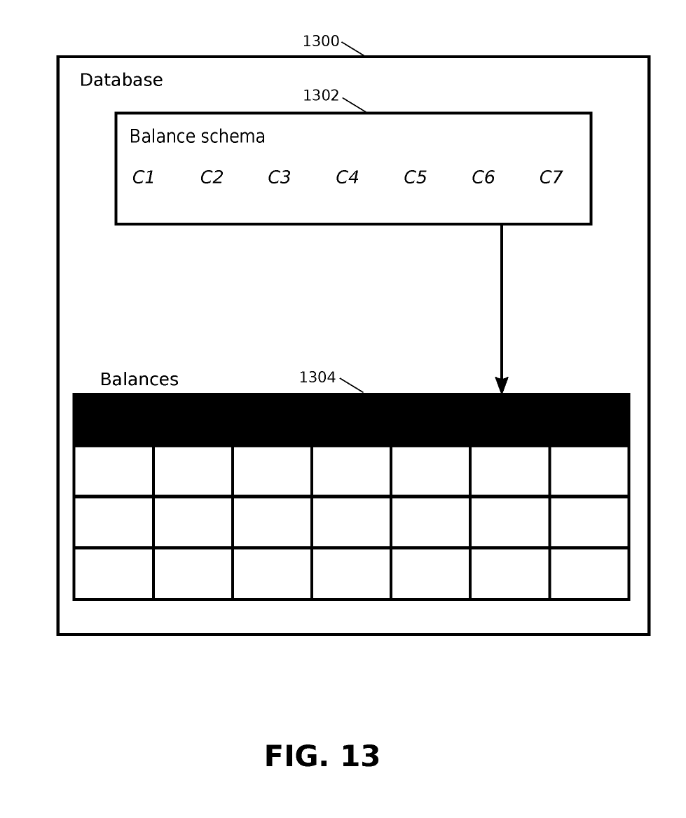

FIG. 13 is a block diagram illustrating a structure of a possible embodiment of a balance record database table 1304, in accordance with an embodiment of the present disclosure.

The balance record database table 1304 may be instantiated in a database 1300.

The database 1300 may comprise a balance record schema 1302, which may specify data fields and associated data structures defining a structure for a balance record contained within the balance record database table 1304.

In a preferred embodiment of the present disclosure, schema element Cl may comprise a string, representing an asset owner name.

Schema element C2 may comprise an integer, string, or other data structure representing a digital identifier for an owner of the digital asset. In an embodiment the digital identifier may comprise: an email address, an IP address, a social security number, a public key of an asymmetric cryptographic key pair, a passport number, an other form of identifier.

Schema element C3 may comprise a string, representing a human readable name for the digital asset.

Schema element C4 may comprise an integer, representing a digital identifier for the digital asset. In other embodiments the schema element C4 may comprise a string, and the digital identifier for the digital asset may comprise a combination of digits and characters.

Schema element C5 may comprise an integer, or in other embodiments a floating point or fixed point number, representing a current balance of the digital asset held by the owner of the digital asset.

Schema element C6 may comprise a data structure, comprising a list of a one or more transaction identifiers that may comprise one or both of: a current transfer transaction, a one or more former transfer transactions, of the digital asset.

Schema element C7 may comprise a time stamp, which in an embodiment of the current disclosure may represent a time at which the balance record was last updated.

It will be apparent to those skilled in the art that an aforementioned schemas C1 . . . C7 represent one of a number of similar representations that may be defined to implement the current disclosure. Furthermore, an order in which the aforementioned schemas are presented may be rearranged with no loss of generality. In other embodiments the records of digital assets may be stored in a schemaless database, wherein each record defines the structure of the data.

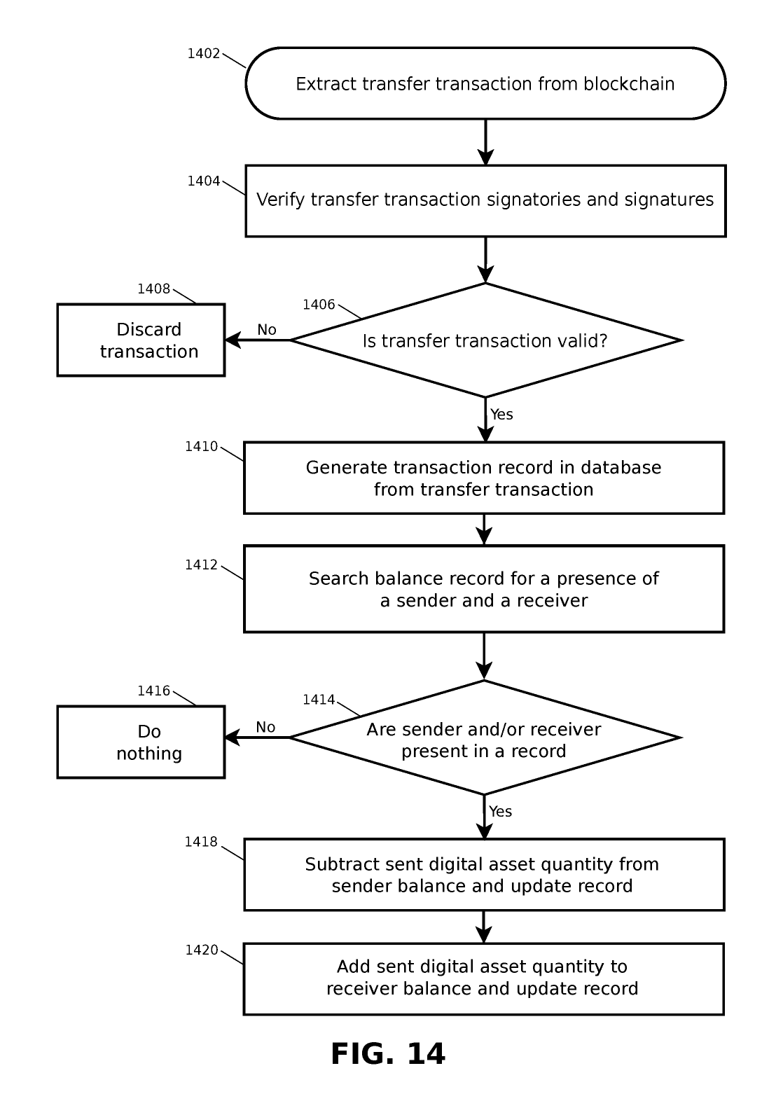

In FIG. 14 a process for updating a balance of the digital asset held by an owner is presented, in accordance with an embodiment of the present disclosure.

Operations may commence by extracting an asset transfer transaction from a block in the blockchain comprising an asset transfer message, as shown in step 1402.

As shown in step 1404, operations may proceed by a verification of a one or more signatories and a one or more associated signatures contained within the asset transfer transaction, producing a validity result.

In step 1406 the validity result is examined. If the validity result is false, operations may proceed to step 1408, the asset transfer transaction may be discarded, and operations may halt.

If the validity result is true, operations may proceed to step 1410.

In step 1410 a transaction record may be generated and included in a transaction record table.

In step 1412 a balance record table may be searched for a presence of a sender and/or a presence of a receiver listed in the transaction record.

In step 1414, if neither the sender nor the receiver are present, operations may proceed to step 1416, and no further actions may be taken. In another embodiment, a balance record may be created for the sender and inserted into the balance record table, and a second balance record may be created for the receiver and inserted into the balance record table. Under this embodiment, operations may then proceed to step 1418.

In step 1414, if the sender is present in a balance record and/or the receiver is present in a second balance record, operations may proceed to step 1418.

In step 1418 a quantity of the digital asset sent may be extracted from the transaction record, the quantity may then be subtracted from a balance in the balance record, and the balance record may be updated in the database table to reflect a subtraction.

In step 1420 a quantity of the digital asset sent may be extracted from the transaction record, the quantity may then be added to a second balance in the second balance record, and the second balance record may be updated in the database table to reflect an addition.

Through the above operations the balance of the sender is decreased and equivalently the second balance of the receiver is increased to reflect a change in an ownership of the digital asset.

For clarity, in a current exemplary embodiment of the present disclosure, an asset transfer from an asset sender to an asset receiver is presented. On reviewing the present disclosure those skilled in the art will appreciate that in other embodiments the transaction may comprise a plurality of asset senders and/or a plurality of asset receivers, and under such other embodiments steps that follow may be conducted multiple times for each one of the plurality of asset senders and/or for each one of the plurality of asset receivers.

Through the above disclosure, a digital asset may be created and transferred on a blockchain, and associated balances and ownership of the digital asset may be tracked, through an interface of a database.

The technology described herein is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, processor-based systems, programmable consumer electronics, network PCs, minicomputers, mainframe computers, smartphones, tablets, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, an Arm®-based Processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic-link library.

The system may be used in connection with various operating systems such as Linux®, UNIX®, iOS®, or Microsoft Windows®.

The system may be written in any conventional programming language such as C, C++, Pascal, or Java, FORTRAN, and run under a conventional operating system. C, C++, Pascal, Java, and FORTRAN are industry standard programming languages for which many commercial compilers can be used to create executable code. The system may also be written using interpreted languages such as Perl, Python or Ruby, or languages that may either be compiled or interpreted, such as BASIC or Lisp.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, micro-controller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, an advantage of the systems and methods of this disclosure includes creating, tracking and transferring quantities of a digital asset through a system of databases, backed up by a blockchain.

What is claimed is:

1. A method for creating digital assets, comprising:
initiating a creation of a digital asset by adding an asset creation record to a database, comprising a quantity of the digital asset, and an identifier of an owner of the digital asset; and
detecting a presence of the asset creation record; and
transmitting an asset creation message to a blockchain, said asset creation message comprising some or all of the contents of the asset creation record; and
verifying that the asset creation message is valid; and
on successful verification, adding the asset creation message to the blockchain; and
retrieving the asset creation message from the blockchain; and
inserting, into a second database, a corresponding record comprising some or all of the asset creation message.

2. The method of claim 1, wherein the owner of the quantity of the digital asset is identified through one or more of: a public cryptographic key, an IP address, an email address, a universal identification number, an identifier data structure.

3. The method of claim 1, wherein the asset creation record further comprises: an initial quantity of the digital asset, a creation rate for further quantities of the digital asset, a condition for a creation of further quantities of the digital asset.

4. A method for transferring digital assets, comprising:
initiating a transferral of a digital asset by adding a transfer record to a database, comprising a quantity of the digital asset, an owner of the digital asset, a receiver for the digital asset, and an authorization for a transfer of the digital asset from the owner to the receiver; and
detecting a presence of the transfer record; and
transmitting an asset transfer transaction to the blockchain, said asset transfer transaction comprising some or all of the transfer record; and
verifying that the asset transfer transaction is valid; and
on a successful verification, adding the asset transfer transaction to a blockchain; and
retrieving the asset transfer transaction from the blockchain; and
inserting, into a second database, a corresponding record, comprising some or all of the asset transfer transaction.

5. The method of claim 4, further comprising:
creating a record in the database, said record comprising a one or more balance records of a one or more owners of a one or more digital assets; and
retrieving the asset transfer transaction from the blockchain; and
determining a change to the one or more balance records; and
updating, adding or deleting the one or more balance records based on a calculation performed using information contained in the asset transfer transaction.

6. The method of claim 4, wherein the asset transfer record further comprises one or more of: a plurality of quantities, a plurality of owners, a plurality of receivers.

7. The method of claim 4, wherein the asset transfer record further comprises a plurality of authorizations, and the successful validation comprises a further successful validation of a given number of the plurality of authorizations.

8. The method of claim 7, wherein the given number comprises a one or more of: a percentage of, a fixed number of, a majority of, or all of, a total number of the plurality of authorizations.

9. The method of claim 4, wherein the asset transfer record further comprises one or more of: a message, a time stamp, a validity period of the asset transfer record, a checksum of some or all of the transfer record.

10. A plurality of network connected devices, each comprising:
one or more processors, and storage media comprising computer instructions, said plurality of network connected devices being connectible via a network to each other, arranged such that when computer instructions are executed on the one or more processors of a one or more of the plurality of network connected devices, operations are caused for creating digital assets, comprising:
initiating a creation of a digital asset, by a first of the plurality of network connected devices, whereby the first of the plurality of network connected devices adds an asset creation record to a database, comprising a quantity of the digital asset, and an identifier of an owner of the digital asset; and
detecting, by a connective component of the first of the plurality of network connected devices, a presence of the asset creation record; and
transmitting, by the connective component of the first of the plurality of network connected devices, to a blockchain, an asset creation message comprising some or all of a content of the asset creation record; and
verifying, by a one or more of the plurality of network connected devices, that the asset creation message is valid; and
on successful verification, adding the asset creation message to the blockchain by the one or more of the plurality of network connected devices; and
retrieving the asset creation message from the blockchain, by a second connective component of a second of the plurality of network connected devices; and
inserting, by the second connective component, into a second database, a corresponding record comprising some or all of the asset creation message.

11. The plurality of network connected devices of claim 10, wherein the owner of the quantity of the digital asset is identified through one or more of: a public cryptographic key, an IP address, an email address, a universal identification number, an identifier data structure.

12. The plurality of network connected devices of claim 10, wherein the asset creation record further comprises: an initial quantity of the digital asset, a creation rate for further quantities of the digital asset, a condition for a creation of further quantities of the digital asset.

13. A plurality of network connected devices, each comprising:
one or more processors, and storage media comprising computer instructions, said plurality of network connected devices being connectible via a network to each other, arranged such that when computer instructions are executed on the one or more processors of a one or more of the plurality of network connected devices, operations are caused for transferring digital assets, comprising:
initiating a transferral of a digital asset, by a first of the plurality of network connected devices, whereby the first of the plurality of network connected devices adds a transfer record to a database, comprising a quantity of the digital asset, an owner of the digital asset, a receiver for the digital asset, and an authorization for a transfer of the digital asset from the owner to the receiver; and
detecting, by a connective component of the first of the plurality of network connected devices, a presence of the transfer record; and
transmitting, by the connective component of the first of the plurality of network connected devices, an asset transfer transaction to the blockchain, said asset transfer transaction comprising some or all of the transfer record; and
verifying, by a one or more of the plurality of network connected devices, that the asset transfer transaction is valid; and
on a successful verification, adding the asset transfer transaction to a blockchain, by the one or more of the plurality of network connected devices; and
retrieving, by a second connective component of a second of the plurality of network connected devices, the asset transfer transaction from the blockchain; and
inserting into a second database, by the second connective component, a corresponding record comprising some or all of the asset transfer transaction.

14. The plurality of network connected devices of claim 13, further comprising:
creating, in the database, by the connective component, a record, said record comprising a one or more balance records of a one or more owners of a one or more digital assets; and
retrieving, by the connective component, the asset transfer transaction from the blockchain; and
determining, by the connective component, a change to the one or more balance records; and
updating, adding or deleting the one or more balance records, based on a calculation performed using information contained in the asset transfer transaction, by the connective component.

15. The plurality of network connected devices of claim 13, wherein the asset transfer record further comprises one or more of: a plurality of quantities, a plurality of owners, a plurality of receivers.

16. The plurality of network connected devices of claim 13, wherein the asset transfer record further comprises a plurality of authorizations, and the successful validation comprises a further successful validation of each of the plurality of authorizations by a given number of the plurality of network connected devices.

17. The plurality of network connected devices of claim 16, wherein the given number comprises one or more of: a percentage of, a fixed number of, a majority of, or all of, the plurality of authorizations.

18. The plurality of network connected devices of claim 11, wherein the asset transfer record further comprises one or more of: a message, a time stamp, a validity period of the asset transfer record, a checksum of some or all of the transfer record.
